(19) United States
(12) Patent Application Publication
(10) Pub. No.: US 2014/0002868 A1
(43) Pub. Date: Jan. 2, 2014

(54) IMAGE CAPTURE DEVICE DUAL-PURPOSE STAND

(71) Applicants: Pedro Landa, Austin, TX (US); Jose Gutierrez, Cedar Park, TX (US)

(72) Inventors: Pedro Landa, Austin, TX (US); Jose Gutierrez, Cedar Park, TX (US)

(21) Appl. No.: 13/610,648

(22) Filed: Sep. 11, 2012

Related U.S. Application Data
(63) Continuation-in-part of application No. PCT/US12/44718, filed on Jun. 28, 2012.

(51) Int. Cl. H04N 1/00

(52) U.S. Cl. CPC H04N 1/00562
USPC 358/473

(57) ABSTRACT

A configurable stand, which in one configuration provides a controlled environment for scanning documents using a portable image capture device, and in another serves double-duty as a writing surface and/or clipboard.

### RELATED APPLICATION

This application is a continuation-in-part of application PCT/US12/44718 filed 28 Jun. 2012, which is hereby incorporated by reference in its entirety.

### BACKGROUND OF THE INVENTION

1. Field of the Invention

The present invention relates to the field of image capture device stands, and the means and methods of supporting said devices, in particular, but not limited to, portable solutions targeting smart phones, tablets, and digital pocket cameras.

2. Description of the Related Art

The recent adoption of smartphones, tablets and digital cameras for use as document capture devices, has produced a need for portable stands. Currently, such stands are sometimes foldable and almost always lightweight, thus increasing their portability. They are also typically single-purpose.

### BRIEF SUMMARY OF THE INVENTION

The present invention comprises a image capture device stand that is designed to serve dual purposes. When in one configuration, the present invention provides a controlled environment for scanning one or more documents or other objects using a portable image capture device such as a smartphone, tablet or digital pocket camera. When in another configuration, the present invention serves double-duty as a writing surface or clipboard.

In at least one preferred embodiment, the present invention includes a means to eliminate a significant amount of outside light, as well as a means to illuminate one or more documents or other items whose image is being captured.

### BRIEF DESCRIPTION OF THE DRAWINGS

FIG. 1 illustrates a preferred embodiment, comprised of a capture device positioning/support lid 101, a foldable vertical support member (hidden), and a document positioning/support base 102, when configured as a clipboard.

FIGS. 2-7 illustrate a preferred embodiment, comprised of a capture device positioning/support lid 201, a foldable vertical support member 203, and a document positioning/support base 202, each figure representing a successive step in the reconfiguration from clipboard to image capture device stand.

FIG. 8 illustrates a preferred embodiment, comprised of a capture device positioning/support lid 801, a foldable vertical support member 803, and a document positioning/support base 802, when fully configured as an image capture device stand. Further, FIG. 8 illustrates a positioning of a document whose image is to be captured, said document having been placed upon said document positioning/support base 802 that has been colored flat-black in order to enhance the captured image.

FIG. 9A illustrates the top side of a capture device positioning/support lid 901 of a preferred embodiment, with an integrated L.E.D. illumination source (hidden).

FIG. 9B illustrates the underside of a capture device positioning/support lid 901 of a preferred embodiment, with an integrated L.E.D. illumination source 905.

FIG. 10 illustrates an L.E.D. illumination source assembly with integrated battery pack, comprising two 9V battery connectors 1001 and 1002, two 9V battery cavities 1005 and 1006 with a means to hold two 9V batteries in place, a on/off switch 1003, and an L.E.D. strip 1004.

### DETAILED DESCRIPTION OF THE INVENTION

The present invention comprises a dual-purpose device that, when in one configuration, provides a controlled environment for scanning documents using a portable image capture device such as a smartphone or digital pocket camera. When in another configuration, the present invention serves as a clipboard or portable writing surface.

The term “image capture device” refers to any electronic or mechanical device that is capable of capturing a visual image of one or more target objects, including but not limited to a smartphone, a portable camera, or portable tablet, said visual image comprising sensitivity in the infrared, visual and/or ultraviolet spectrums. The term “clipboard” refers to a small writing board with a means for holding one or more pieces of paper perhaps bound into a writing pad, serving as a portable writing surface.

The term “hinge” refers to means that connects two solid objects, allowing only a limited angle of rotation between them. A hinge may be constructed of flexible material or of moving components. Further, a hinge may be a specially constructed section of one or both of the solid objects to which it is connected, or it may be separate self-contained assembly which is then attached to said solid objects. For example, a hinge might comprise a section of corrugated cardboard which has been collapsed and reinforced so as to be both flexible and durable along the desired angle of rotation.

The preferred embodiments illustrated and referred to herein are constructed using any single material, or combination of materials, with sufficient rigidity to support one or more types of image capture devices, said material including but not limited to solid, laminated or corrugated cardboard, foam board, wood, plastic, or aluminum.

The preferred embodiments illustrated and referred to herein may comprise fastening means based upon tabs and slots, magnetism, hook and loop mechanisms, or other similar means, or some combination thereof. In at least one preferred embodiment, said fastening means is used to retain said preferred embodiment in a configuration which enables said preferred embodiment to function as an image capture device. In at least one preferred embodiment, said fastening means is used to retain said preferred embodiment in a configuration which enables said preferred embodiment to function as in a clipboard or portable writing surface.

The preferred embodiments illustrated and referred to herein may comprise a light source powered by a battery, capacitor, solar cell, external power supply, or other means, said light source comprising one or more incandescent, fluorescent, light emitting diode, or other light-producing means.

In at least one preferred embodiment, a base is at least partially colored flat black to provide better delineation of the edges of the one or more objects whose image is to be captured.

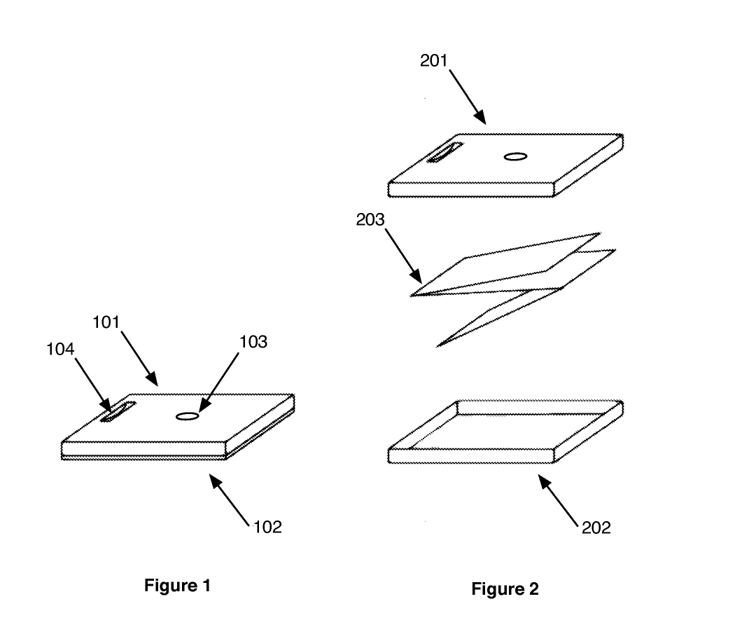

Referring to FIG. 1, in at least one preferred embodiment, the present invention comprises a lid 101, a base 102, and a foldable supporting member which fits inside a boxed-shaped container that is formed when said lid 101 is placed over said base 102. Lid 101 includes an opening 103, over which an image capture device, such as a smartphone or digital pocket camera, is positioned such that its lens can capture an image of a document or other object placed underneath said lid 101. Lid 101 also includes a clamping means 104, such that said preferred embodiment can be used as a writing surface and/or clipboard.

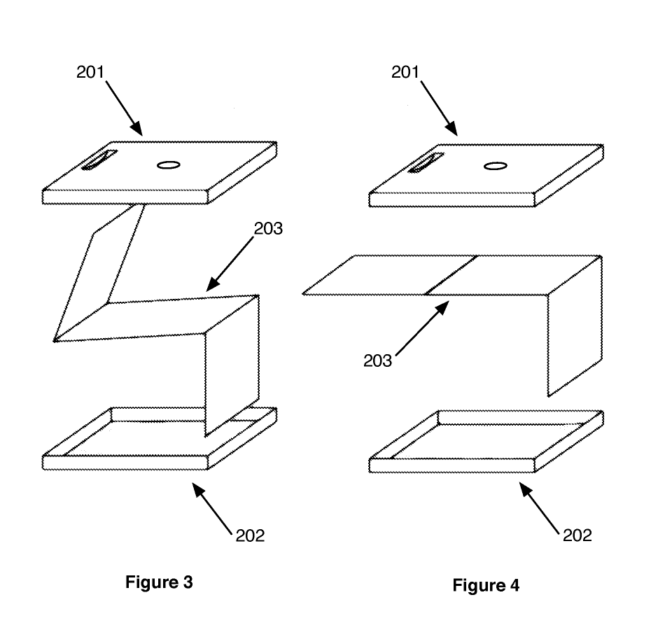

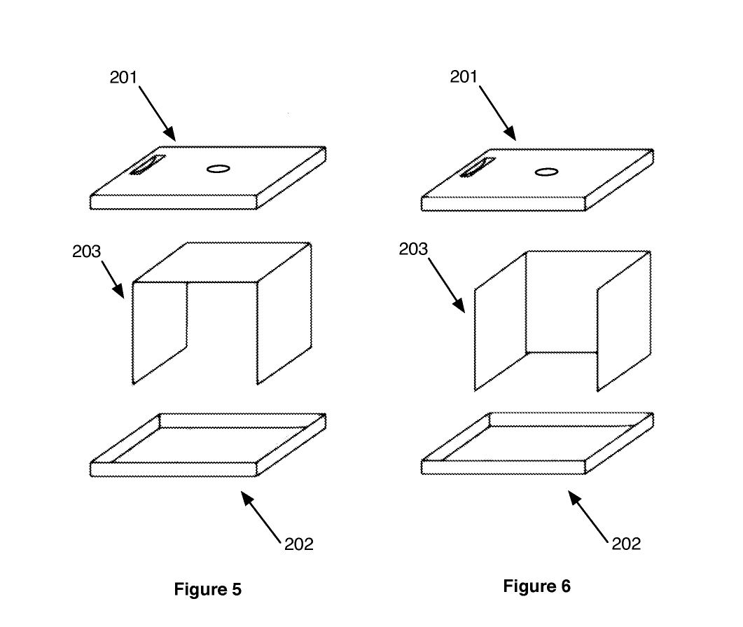

FIGS. 2-7 illustrate the intermediate steps involved in reconfiguring the preferred embodiment of FIG. 1, for use as an image capture device stand. Lid 201 is separated from base 202, and foldable support member 203 is then unfolded and rotated as illustrated, and positioned as shown in FIG. 7 in such a way as to provide support for lid 201 (see FIG. 8).

FIG. 8 illustrates a variation of the preferred embodiment of FIG. 1, when fully configured for use as an image capture device stand. Said embodiment comprises a lid 801, a base 802, and a foldable supporting member 803. Lid 801 includes an opening 804, over which an image capture device, such as a smartphone or digital pocket camera, is positioned such that its lens can capture an image of a document 806 or other object placed underneath said lid 801. Lid 801 also includes a clamping means 805, such that said preferred embodiment can be used as a writing surface and/or clipboard. Further, said support base 802 has been colored flat-black in order to enhance the captured image of said target document 806.

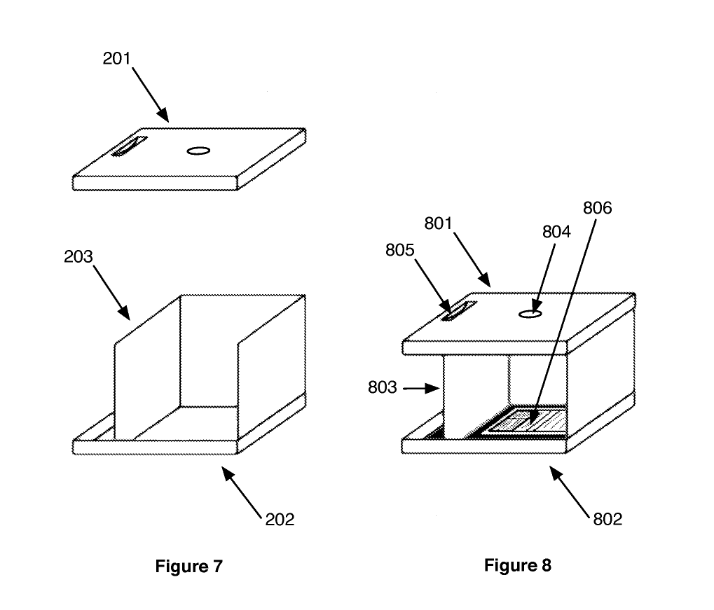

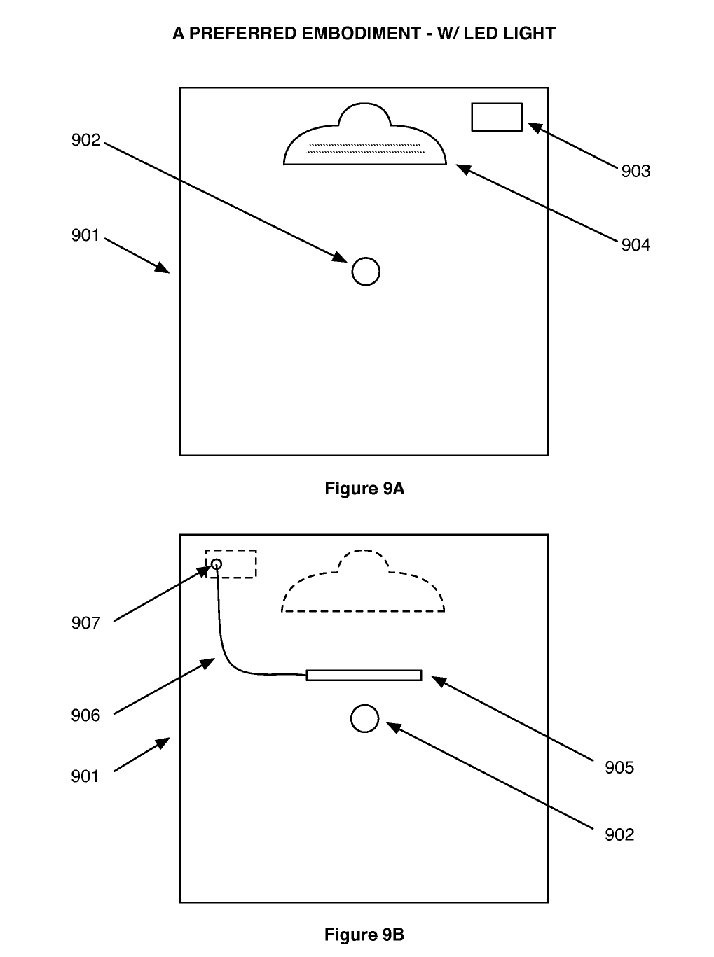

FIGS. 9A and 9B illustrate in detail the layout of the lid of an enhanced version of the preferred embodiment of FIGS. 1-8. In particular, FIG. 9A illustrates the underside of said lid, detailing the placement of an L.E.D. strip 905, which is supplied with power via a wire 906. which is in turn attached to a battery pack/switch assembly 903 through an opening 907 in said panels. FIG. 9B also illustrates the placement of a clamping means 904, which enables this embodiment to be used as a writing surface and/or clipboard, when so configured and not in use as an image capture device stand.

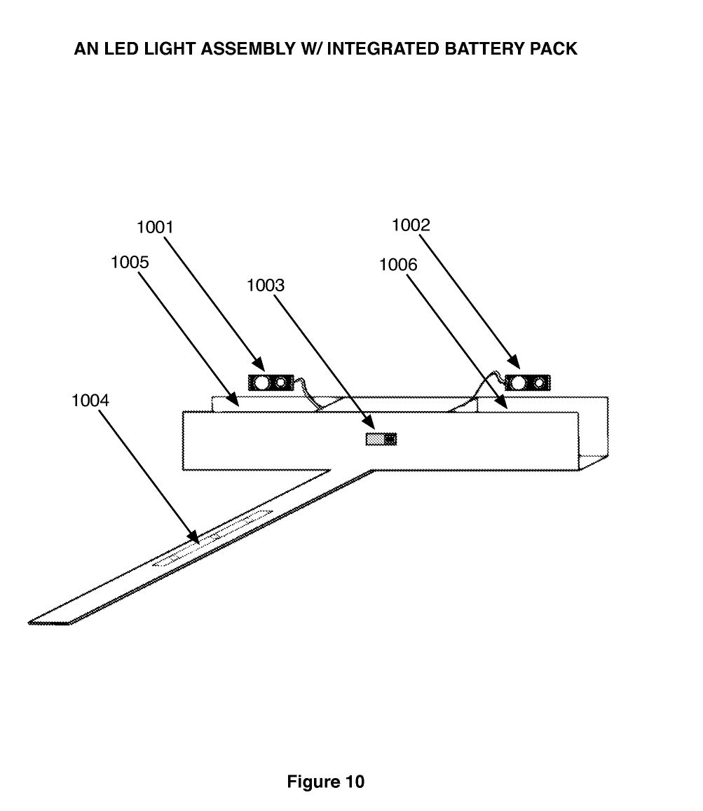

In at least one preferred embodiment, the underside of the lid comprises an L.E.D. light assembly 1004 with an integrated battery pack and on/off switch 1003, as illustrated in FIG. 10. Said assembly in positioned in such a way as to center said L.E.D. light assembly 1004 over the target document when said embodiment is configured as an image capture device stand, and as to not interfere with the ability of the lid to close around the base when said embodiment is configured as a clipboard and/or writing surface.

We claim:

1. An image capture device dual-purpose stand, comprising:
a base, including means to retain by gravity or other means at least a first object whose image is to be captured;
a lid, wherein said lid includes an opening through which an image capture device can capture an image when said dual-purpose stand is in a first configuration and said capture device is placed lens-down over said opening;
wherein said lid includes a clamping apparatus whereby said lid can serve as a writing surface and clipboard when said dual-purpose stand is in a second configuration; and
at least a first supporting member, comprising a foldable panel, which when folded can be stored inside a container formed by placing said lid over said base, and when unfolded forms a vertical supporting structure which can be placed between said base and said lid to hold said lid at a distance from said base that is appropriate for image capture.

2. The image capture device dual-purpose stand of claim 1, wherein said lid includes means to illuminate at least said first object whose image is to be captured.

3. The image capture device dual-purpose stand of claim 1, wherein said base and said lid are rectangular in shape, wherein said first supporting member comprises three panels, A, B, and C, wherein a first edge of panel A is connected to a first edge of panel B using a first hinge, and a first edge of panel C is connected to a second edge of panel B using a second hinge, wherein said second edge of panel B is directly opposite said first edge of panel B.

4. The image capture device dual-purpose stand of claim 3, wherein said lid includes means to illuminate at least said first object whose image is to be captured.

5. The image capture device dual-purpose stand of claim 4, wherein said base, said lid, and said supporting member are constructed from corrugated cardboard.

6. The image capture device dual-purpose stand of claim 4, wherein said base, said lid, and said supporting member are constructed from solid polyurethane plastic.

7. The image capture device dual-purpose stand of claim 4, wherein said base said lid, and said supporting member are constructed from solid aluminum.

8. The image capture device dual-purpose stand of claim 4, wherein said base, said lid, and said supporting member are constructed from laminated cardboard.
